(19) United States
(12) Patent Application Publication
(10) Pub. No.: US 2015/0248152 A1
(43) Pub. Date: Sep. 3, 2015

(54) BATTERY WITH INTEGRATED POWER TIMER

(71) Applicant: International Business Machines Corporation, Armonk, NY (US)

(72) Inventors: Eugen Postea, Thornhill (CA); Aaron J. Quirk, Cary, NC (US); Carlos L. Torres, Durham, NC (US); Giovanni Viera, Durham, NC (US)

(73) Assignee: International Business Machines Corporation, Armonk, NY (US)

(21) Appl. No.: 14/192,897

(22) Filed: Feb. 28, 2014

(51) Int. Cl. G06F 1/28

(52) U.S. Cl. CPC G06F 1/28

(57) ABSTRACT

Controlling power output is provided. A processing circuit that is incorporated with a battery receives a schedule that identifies at least one interval value, wherein the battery has a form factor that complies with a form factor standard. The processing circuit determines a first power state based, at least in part, on a first interval value of the at least one interval value. The processing circuit determines, based, at least in part, on the first power state, whether to interrupt a power output of the battery and, if so, the processing circuit interrupts the power output of the battery.

### FIELD OF THE INVENTION

The present disclosure relates generally to the field of batteries and more particularly to a battery with an integrated power timer.

### BACKGROUND OF THE INVENTION

In electronics, a battery is a device consisting of one or more electrochemical cells that convert stored chemical energy into electrical energy. Each cell contains a positive terminal, or cathode, and a negative terminal, or anode. Electrolytes allow ions to move between the electrodes and terminals, which allows power (i.e., current) to flow out of the battery.

Primary (single-use or “disposable”) batteries are used once and discarded; the electrode materials are irreversibly changed during discharge. Common examples are the alkaline battery, which can be used for a multitude of portable devices, such as flashlights. Secondary (rechargeable batteries) can be discharged and recharged multiple times; the original composition of the electrodes can be restored by reverse current. Examples include the lead-acid batteries used in vehicles and lithium ion batteries used for portable electronics. Batteries come in many shapes and sizes, from miniature cells used to power hearing aids and wristwatches to battery banks the size of rooms that provide standby power for telephone exchanges and computer data centers.

Standards-setting organizations, including the American National Standards Institute (ANSI) and the International Electrotechnical Commission (IEC), have established various standardized sizes of batteries. Such standards enable compatibility between batteries and electronic devices of various manufacture. Common standardized battery sizes include AAA, AA, C, D, and 9-volt, each of which corresponds to one or more standards specified by organizations such as ANSI and IEC. For example, an alkaline AA battery corresponds to both IEC standard LR6 and ANSI standard 15A.

### SUMMARY

Embodiments of the present invention provide a method, system, and computer program product for controlling power output. A processing circuit that is incorporated with a battery receives a schedule that identifies at least one interval value, wherein the battery has a form factor that complies with a form factor standard. The processing circuit determines a first power state based, at least in part, on a first interval value of the at least one interval value. The processing circuit determines, based, at least in part, on the first power state, whether to interrupt a power output of the battery and, if so, the processing circuit interrupts the power output of the battery.

### BRIEF DESCRIPTION OF THE SEVERAL VIEWS OF THE DRAWINGS

FIG. 1 is a functional block diagram illustrating a computing environment, in accordance with an embodiment of the present disclosure.

FIG. 2 is a functional block diagram of battery 102 in accordance with an embodiment of the present disclosure.

FIG. 3 is a flowchart depicting the operations implemented by timing circuit 202, within battery 102, for selectively interrupting power output from battery 102, in accordance with an embodiment of the present disclosure.

FIG. 4 depicts a block diagram of components of an interface device executing a scheduling program, in accordance with an embodiment of the present disclosure.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present disclosure will now be described in detail with reference to the Figures.

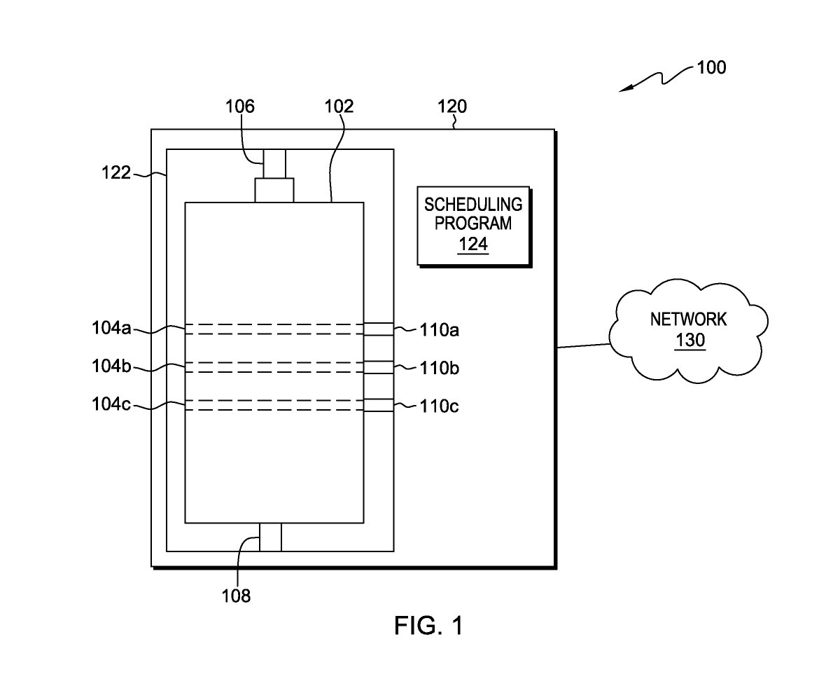

FIG. 1 is a functional block diagram illustrating a computing environment, generally designated 100, in accordance with one embodiment of the present disclosure. Computing environment 100 includes interface device 120, battery 102, and network 130.

Network 130 can be, for example, a local area network (LAN), a wide area network (WAN) such as the Internet, or a combination of the two, and can include wired, wireless, or fiber optic connections. In general, network 130 can be any combination of connections and protocols that will support communications to and from interface device 120.

Battery 102 may be a dry cell battery sized to comply with a standard form factor. The form factor of battery 102 includes the size, shape, and proportions of battery 102. Battery 102 includes contact bands 104a, 104b, and 104c (collectively referred to as contact bands 104). Battery 102 has a form factor that may comply with a standard promulgated by ANSI, IEC, or both. For example, the form factor of battery 102 may comply with IEC size R6, as specified by international standard IEC 60086, which is the size standard for batteries commonly referred to as size “AA” batteries. Alternatively, the form factor of battery 102 may comply with other standard battery sizes, e.g., AAA, C, D, or 9-volt, each of which corresponds to one or more standards promulgated by ANSI, IEC, or both. Alternatively, the form factor of battery 102 may be non-standard.

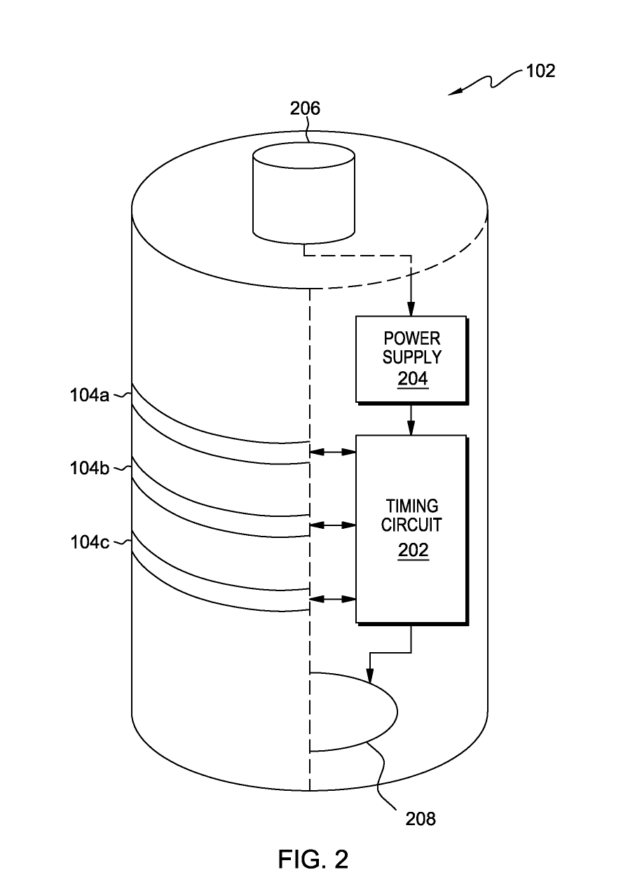

Contact bands 104 may be conductive annular surfaces disposed upon the outer surface of battery 102. Each of contact bands 104 may be disposed within a channel in the outer surface of a cylindrical portion of battery 102 so that the outer surface of each of contact bands 104 is flush with the adjacent portions of the outer surface of the cylindrical portion of battery 102. Thus, contact bands 104 may be positioned to preserve the cylindrical shape of the cylindrical portion of battery 102. For example, contact bands 104 may be disposed within channels of the outer surface of battery 102 that have a depth equal to the thickness of contact bands 104, thereby maintaining the form factor of battery 102. Alternatively, contact bands 104 may protrude from battery 102 relative to the outer surface of battery 102, or may be recessed relative to the outer surface of battery 102, or a combination thereof. Some or all of contact bands 104 may completely or partially encircle battery 102. For example, contact bands 104 may be contact spots positioned at a point along the circumference of the cylindrical portion of battery 102. In various embodiments, contact bands 104 may include a greater or fewer number of contact bands than depicted. Contact bands 104 are each positioned to engage a conductive surface of interface device 120. When so engaged, contact bands 104 communicatively link timing circuit 202 (see FIG. 2) to interface device 120.

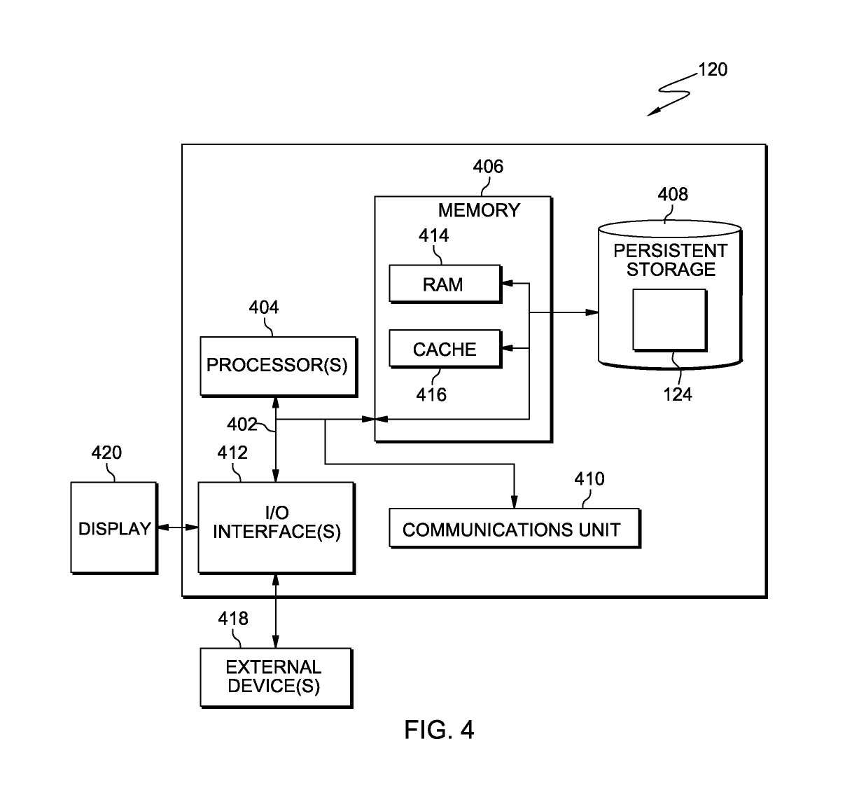

Interface device 120 includes cradle 122 and scheduling program 124. Cradle 122 may be a recess within a body of interface device 120 sized to receive battery 102. Cradle 122 includes cathode contact 106, anode contact 108, and interface contacts 110a, 110b, and 110c (collectively referred to as interface contacts 110). Interface device 120 may be a battery charger that provides power (i.e., current) to battery 102 via cathode contact 106 and anode contact 108 in order to charge battery 102. For example, interface device 120 may receive power from an external power source (not shown), which interface device 120 may route to battery 102. Interface contacts 110 of interface device 120 may engage contact bands 104 of battery 102 in order to enable communication between scheduling program 124 and timing circuit 202 (see FIG. 2). Interface device 120 may include internal and external hardware components, as depicted and described in further detail with respect to FIG. 4.

Scheduling program 124 operates to receive input (e.g., from a user of interface device 120) and to transmit a power schedule to battery 102. In one embodiment, scheduling program 124 resides on interface device 120. In other embodiments, scheduling program 124 may reside on another computing device or another computing system, provided that scheduling program 124 can access battery 102. Scheduling program 124 may provide a user interface. In response, scheduling program 124 may receive input, based upon which scheduling program 124 may determine a power schedule.

The power schedule may be a series of bits of data that comply with a pre-determined format in order to represent values of various types. The types of values represented by the power schedule may include interval values, power status values, a repetition bit, or a combination thereof. Each value of the power schedule is represented by one or more bits. For example, a power state value may be represented by a single bit, wherein zero and one each represent one of two possible power states. Alternatively, the power state value may be represented by more than one bit. Each interval value represents a duration of time. Interval values can be restricted to positive numbers. For example, an interval value may indicate a quantity of seconds or a quantity of milliseconds. The number of bits used to represent a time increment may vary depending upon the precision and maximum value of the time increment. Each interval value of the power schedule may be preceded (or, alternatively, followed) by a power state indicator that corresponds to the interval value. The power schedule may include a repetition bit, the value of which indicates whether to repeat the power schedule in response to reaching the end of the power schedule. For example, the repetition bit may be the last bit (or, alternatively, the first bit) of the power schedule.

FIG. 2 is a functional block diagram of battery 102, in accordance with an embodiment of the present disclosure. Battery 102 may be present within computing environment 100 or independently of computing environment 100. For example, battery 102 may be connected to interface device 120 to receive a power schedule, for charging, or a combination thereof. Alternatively, battery 102 may be present independently of computing environment 100, such as while engaged by an electronic device in order to provide power (i.e., electrical energy) to the electronic device. Battery 102 includes contact bands 104, timing circuit 202, power supply 204, cathode 206, and anode 208.

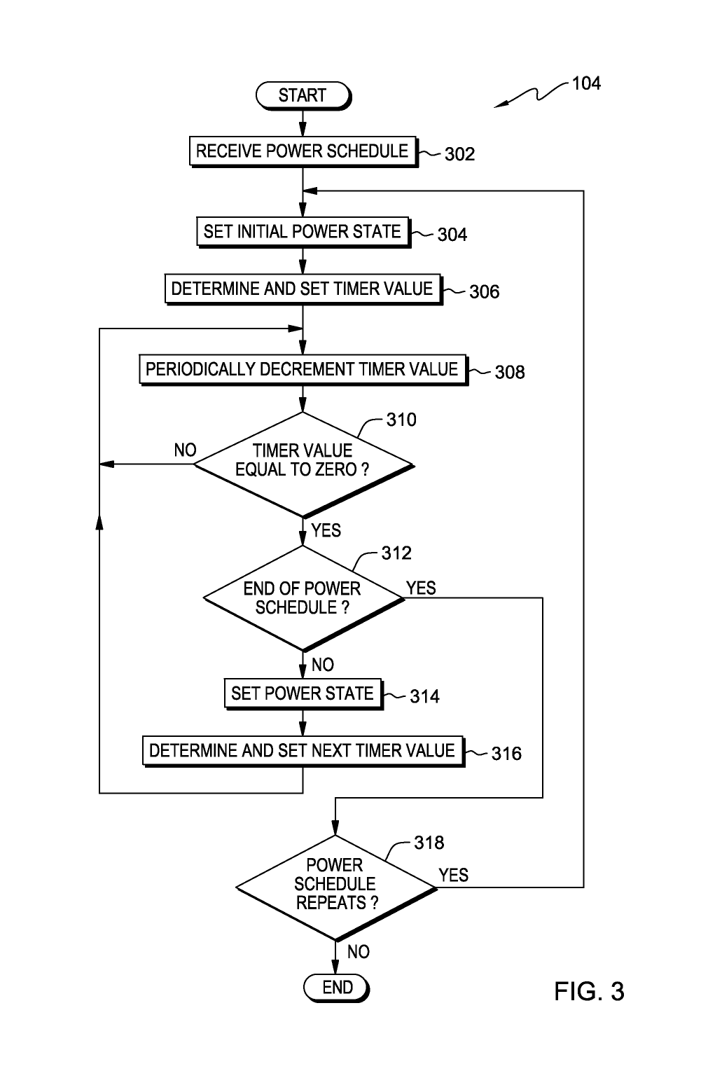

Timing circuit 202 is an integrated circuit (IC) or a processing circuit that may reside within battery 102. Timing circuit 202 operates to selectively interrupt the flow of power between anode 206 and cathode 208, thereby controlling the power output of battery 102. Timing circuit 202 may receive a schedule from contact bands 104. The schedule may include a series of interval values. Timing circuit 202 may include non-volatile storage (e.g., EPROM) capable of storing the schedule. Timing circuit 202 may execute stored program instructions by software, hardware, or a combination thereof. Timing circuit 202 can break or complete a portion of a circuit between anode 206 and cathode 208. For example, timing circuit 202 may include a switch, such as a transistor that is capable of selectively interrupting the flow of current through the transistor by allowing or disallowing the flow of current. The transistor may be a bipolar junction transistor, which allows or disallows the flow of current through the transistor dependent upon whether the transistor receives current. For example, the transistor may be a PNP transistor or an NPN transistor. Timing circuit 202 can selectively interrupt power output of battery 102 by enabling or disabling electrical connectivity between cathode 206 and anode 208. Timing circuit 202 is positioned between cathode 206 and anode 208, either before or after power supply 204. In order to minimize power consumption, timing circuit 202 may be a low-power circuit. For example, timing circuit 202 may consume five or fewer milli-amps. Timing circuit 202 implements the method described in further detail in connection with FIG. 3.

Power supply 204 represents one or more battery cells. The battery cells of power supply 204 can be, for example, dry cells, wet cells, or reserve cells. The battery cells of power supply 204 can be secondary (i.e., rechargeable) cells or primary (i.e., non-rechargeable) cells. Battery 102 may provide power output from power supply 204 when battery 102 joins a completed circuit that includes cathode 206 and anode 208, for example when battery 102 is inserted into a battery-operable electronic device. Timing circuit 202 and power supply 204 are each connected to the portion of the circuit between cathode 206 and anode 208. Timing circuit 202 and power supply 204 may be connected to the circuit in any order relative to one another. Timing circuit 202 can selectively interrupt a portion of the circuit between cathode 206 and anode 208, thereby controlling the power output of battery 102.

FIG. 3 is a flowchart depicting the operations implemented by timing circuit 202, within battery 102, for selectively interrupting power output from battery 102, in accordance with an embodiment of the present disclosure.

In step 302, timing circuit 202 receives a power schedule. The power schedule may include a series of interval values. Each interval value may represent a time period. For example, each interval value may indicate a quantity of seconds, or, alternatively, a quantity of milliseconds. Timing circuit 202 may receive the power schedule from interface device 120 via contact bands 104. In various examples, interface device 120 can receive a power schedule as user input, from another computing device via network 130, from storage residing in interface device 120, or a combination thereof. Timing circuit 202 can track a current position within the power schedule. The current position may represent an offset (e.g., in number of bits) from the beginning of the power schedule. The current position may initially represent an offset of zero.

In step 304, timing circuit 202 sets an initial power state. Timing circuit 202 sets the power state to enable or disable interruption of the flow of power between cathode 206 and anode 208. Timing circuit 202 may set the initial power state based on the power schedule. For example, timing circuit 202 may set the initial power state based on the power state indicator next following the current position, which may be a power state indicator corresponding to an interval value. Alternatively, timing circuit 202 sets the initial power state based on a default power state. Timing circuit 202 may receive the default power state (e.g., from interface device 120). Timing circuit 202 may store the default power state in non-volatile memory (e.g., EPROM). Timing circuit 202 may enable (or, alternatively, disable) the power output of battery 102 based on the default power state.

In step 306, timing circuit 202 determines and sets a timer value. Timing circuit 202 may determine the timer value based on a series of interval values of the power schedule. Timing circuit 202 may determine the timer value based on the earliest occurring interval value of the series of interval values. For example, the timer value may be a value equal to (or a multiple of) the earliest occurring interval value of the series of interval values. Alternatively, the timer value may be a value equal to the interval value occurring next following the current position within the power schedule. Timing circuit 202 sets the timer value to the determined timer value.

In step 308, timing circuit 202 periodically decrements the timer value. Timing circuit 202 may generally remain in a minimal power state and wake in regular intervals in order to decrement the timer value. Timing circuit 202 may decrement the timer value by an amount equal to the duration of the regular intervals. For example, timing circuit 202 may wake once per second, in which case timing circuit decrements the timer value by one second. Alternatively, timing circuit 202 may wake twice per second, in which case timing circuit 202 decrements the timer value by five hundred milliseconds. In some embodiments, timing circuit 202 wakes irregularly, in which case timing circuit 202 decrements the timer value by an amount equal to the time lapse since timing circuit 202 last woke.

In decision 310, timing circuit 202 determines whether the timer value is equal to zero. If timing circuit 202 determines that the timer value is not equal to zero (decision 310, NO branch), then timing circuit 202 periodically decrements the timer value (step 308). If timing circuit 202 determines that the timer value is equal to zero (decision 310, YES branch), then timing circuit 202 toggles the power state (step 312).

In decision 312, timing circuit 202 determines whether timing circuit 202 has reached the end of the power schedule. Timing circuit 202 may determine that timing circuit 202 has reached the end of the power schedule based on the interval values or power state values at or after the current position included in the power schedule. Alternatively, timing circuit 202 may determine whether timing circuit has reached the end of the power schedule based on whether the current position represents an offset from the start of the power schedule that is equal to the length of the power schedule. If timing circuit 202 determines that timing circuit 202 has reached the end of the power schedule (decision 312, YES branch), then timing circuit 202 determines the power schedule repeats (decision 318, discussed below). If timing circuit 202 determines that the power schedule is not complete (decision 312, NO branch), then timing circuit 202 sets the power state (step 314).

In step 314, timing circuit 202 sets the power state. Timing circuit 202 may set the power state based on a power state indicator of the power schedule. For example, the power state indicator may be a power state indicator corresponding to an interval value next following the current position of timing circuit 202 within the power schedule. Alternatively, the power schedule may lack power state indicators after the current position of timing circuit 202 within the power schedule, in which case timing circuit 202 may set the power state by toggling the power state.

In step 316, timing circuit 202 determines and sets the next timer value. Timing circuit 202 may determine the next timer value by identifying an interval value next following the current position of timing circuit 202 within the power schedule. For example, timing circuit 202 may determine the next timer value to be a value equal to the identified interval value. Timing circuit 202 sets the timer value to the next timer value and returns to periodically decrementing the timer value (step 308).

In decision 318, timing circuit 202 determines whether the power schedule repeats. Timing circuit 202 may determine whether the power schedule repeats based on the value of a repeat bit. For example, timing circuit 202 may determine that the power schedule repeats if the value of the repeat bit is one, and timing circuit 202 may determine that the power schedule does not repeat if the value of the repeat bit is zero. If timing circuit 202 determines that the power schedule repeats (decision 318, YES branch), then timing circuit 202 sets an initial power state (step 304) and proceeds therefrom. Timing circuit 202 may also set the current position to the beginning of the power schedule in response to determining that the power schedule repeats (decision 318, YES branch). If timing circuit 202 determines that the power schedule does not repeat (decision 318, NO branch), then the operations depicted in FIG. 3 end.

FIG. 4 depicts a block diagram of components of interface device 120 in accordance with an illustrative embodiment of the present disclosure. It should be appreciated that FIG. 4 provides only an illustration of one implementation and does not imply any limitations with regard to the environments in which different embodiments may be implemented. Many modifications to the depicted environment may be made.

Interface device 120 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Scheduling program 124 is stored in persistent storage 408 for execution by one or more of the respective computer processor(s) 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of other computing devices via network 130. In these examples, communications unit 410 includes one or more network interface cards. Communications unit 410 may provide communications through the use of either or both physical and wireless communications links. Scheduling program 124 may be downloaded to persistent storage 408 through communications unit 410.

I/O interface(s) 412 allows for input and output of data with other devices that may be connected to interface device 120. For example, I/O interface(s) 412 may provide a connection to external devices 418 such as a keyboard, a keypad, a touch screen, and/or some other suitable input device. External devices 418 can also include portable computer-readable storage media such as, for example, thumb drives, portable optical or magnetic disks, and memory cards. Software and data used to practice embodiments of the present disclosure, e.g., scheduling program 124, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

What is claimed is:

1. A method for controlling power output, the method comprising:
receiving, by a processing circuit that is incorporated with a battery, a schedule that identifies at least one interval value, wherein the battery has a form factor that complies with a form factor standard;
determining, by the processing circuit, a first power state based, at least in part, on a first interval value of the at least one interval value; and
determining, by the processing circuit, based, at least in part, on the first power state, whether to interrupt a power output of the battery and, if so, interrupting, by the processing circuit, the power output of the battery.

2. The method of claim 1, further comprising:
determining, by the processing circuit, one or more time intervals based, at least in part, on the one or more time values; and
determining, by the processing circuit, whether to interrupt power during each of the one or more time intervals and, if so, interrupting the power output of the battery.

3. The method of claim 1, wherein interrupting the power output of the battery includes interrupting a flow of current between an anode of the battery and a cathode of the battery.

4. The method of claim 1, wherein the first interval value corresponds to a first power state value that indicates a power state, and wherein determining the first power state is further based, at least in part, on the first power state value.

5. The method of claim 1, wherein the form factor standard is selected from a group consisting of: a AA form factor standard, a AAA form factor standard, a C form factor standard, a D form factor standard, and a 9-volt form factor standard.

6. The method of claim 1, wherein the processing circuit receives the schedule via an interface of the battery that comprises one or more contact portions disposed upon an outer surface of the battery.

7. The method of claim 6, wherein the processing circuit receives the schedule via the interface from an interface device.

8. The method of claim 7, wherein the interface device is a battery charger.

9. A computer program product for controlling power output, the computer program product comprising a computer readable storage medium having program instructions embodied therewith, the program instructions executable by a processing circuit to perform a method comprising:
receiving, by a processing circuit that is incorporated with a battery, a schedule that identifies at least one interval value, wherein the battery has a form factor that complies with a form factor standard;
determining, by the processing circuit, a first power state based, at least in part, on a first interval value of the at least one interval value; and
determining, by the processing circuit, based, at least in part, on the first power state, whether to interrupt a power output of the battery and, if so, interrupting, by the processing circuit, the power output of the battery.

10. The computer program product of claim 9, wherein the method further comprises:
determining, by the processing circuit, one or more time intervals based, at least in part, on the one or more time values; and
determining, by the processing circuit, whether to interrupt power during each of the one or more time intervals and, if so, interrupting the power output of the battery.

11. The computer program product of claim 9, wherein interrupting the power output of the battery includes interrupting a flow of current between an anode of the battery and a cathode of the battery.

12. The computer program product of claim 9, wherein the first interval value corresponds to a first power state value that indicates a power state, and wherein determining the first power state is further based, at least in part, on the first power state value.

13. The computer program product of claim 9, wherein the form factor standard is selected from a group consisting of: a AA form factor standard, a AAA form factor standard, a C form factor standard, a D form factor standard, and a 9-volt form factor standard.

14. The computer program product of claim 9, wherein the processing circuit receives the schedule via an interface of the battery that comprises one or more contact portions disposed upon an outer surface of the battery.

15. A system for controlling power output, the system comprising:
a processing circuit that is incorporated with a battery in communication with a memory, wherein the processing circuit is configured to perform a method, said method comprising:
receiving, by the processing circuit, a schedule that identifies at least one interval value, wherein the battery has a form factor that complies with a form factor standard;
determining, by the processing circuit, a first power state based, at least in part, on a first interval value of the at least one interval value; and
determining, by the processing circuit, based, at least in part, on the first power state, whether to interrupt a power output of the battery and, if so, interrupting, by the processing circuit, the power output of the battery.

16. The system of claim 15, wherein the method further comprises:
determining, by the processing circuit, one or more time intervals based, at least in part, on the one or more time values; and
determining, by the processing circuit, whether to interrupt power during each of the one or more time intervals and, if so, interrupting the power output of the battery.

17. The system of claim 15, wherein interrupting the power output of the battery includes interrupting a flow of current between an anode of the battery and a cathode of the battery.

18. The system of claim 15, wherein the first interval value corresponds to a first power state value that indicates a power state, and wherein determining the first power state is further based, at least in part, on the first power state value.

19. The system of claim 15, wherein the form factor standard is selected from a group consisting of: a AA form factor standard, a AAA form factor standard, a C form factor standard, a D form factor standard, and a 9-volt form factor standard.

20. The system of claim 15, wherein the processing circuit receives the schedule via an interface of the battery that comprises one or more contact portions disposed upon an outer surface of the battery.
